(19) United States
(12) Patent Application Publication
(10) Pub. No.: US 2023/0356160 A1
(43) Pub. Date: Nov. 9, 2023

(54) INFORMATION PROCESSING DEVICE, INFERENCE DEVICE, MACHINE LEARNING DEVICE, SUBSTRATE PLATING DEVICE, INFORMATION PROCESSING METHOD, INFERENCE METHOD, AND MACHINE LEARNING METHOD

(71) Applicant: EBARA CORPORATION, Tokyo (JP)

(72) Inventor: RYUYA KOIZUMI, Tokyo (JP)

(73) Assignee: EBARA CORPORATION, Tokyo (JP)

(21) Appl. No.: 18/324,156

(22) Filed: May 26, 2023

(30) Foreign Application Priority Data
May 5, 2022 (JP) 2022-126524

(51) Int. Cl. B01F 35/22; B01F 35/10; B01F 35/221

(52) U.S. Cl. CPC B01F 35/2201; B01F 35/10; B01F 35/22142; B01F 2101/58

(57) ABSTRACT

An information processing device includes: an information acquiring part configured to acquire plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motions being operational motions performed by a substrate plating device; and an information generating part configured to generate agitating-motion paddle vibration information in response to the plating process information by inputting the plating process information acquired by the information acquiring part to a learning model which has learned a correlation between the plating process information and the agitating-motion paddle vibration information using machine learning.

### CROSS-REFERENCE TO RELATED APPLICATION

This application claims the priority benefits of Japanese application no. 2022-126524, filed on Aug. 8, 2022. The entirety of the above-mentioned patent application is hereby incorporated by reference herein and made a part of this specification.

### BACKGROUND

### Technical Field

The disclosure relates to an information processing device, an inference device, a machine learning device, a substrate plating device, an information processing method, an inference method, and a machine learning method.

### Description of Related Art

In a substrate plating device forming a predetermined plating film on a substrate, a plating process is performed while agitating a plating solution stored in a plating tank using an agitation part (a paddle) agitating the plating solution (for example, see Patent Document 1 and Patent Document 2).

### PATENT DOCUMENTS

[Patent Document 1] Japanese Patent Laid-Open No. 2006-152377
[Patent Document 2] Japanese Patent Laid-Open No. 2009-299128

As disclosed in Patent Document 1 and Patent Document 2, when the plating solution is agitated using a paddle, mechanical components such as a power transmission mechanism and a power conversion mechanism and electrical components such as a motor are used as constituent components for operating the paddle. Since an abnormality such as damage, fracture, or abrasion is assumed to occur in such constituent components due to a certain unexpected event or aging deterioration, it is necessary to monitor occurrence of an abnormality in the paddle or the constituent components.

At that time, for example, it is conceivable that a sensor detecting vibration be attached to the paddle and occurrence of an abnormality in the paddle or the constituent components be monitored based on detection values from the sensor. However, in an operational motion of the substrate plating device, when a plating process is performed, constituent parts such as a carrier machine carrying a substrate and a pump circulating the plating solution in addition to the paddle are appropriately operated according to a process status of the plating process and thus vibration due to the operation thereof is also detected by the sensor. As a result, the detection values from the sensor also include various types of noise in a superposable manner and thus it is difficult to determine occurrence of an abnormality in the paddle due to an influence of the noise even if the detection values from the sensor are analyzed. Since the carrying and plating processes of a substrate W are sequentially performed in the operational motions of the constituent parts, timings or control parameters (such as a speed and a positional relationship) when the constituent parts operate are not constant and an influence of noise also varies from time to time. Accordingly, it is difficult to appropriately remove only the noise from the detection values from the sensor.

The disclosure provides an information processing device, an inference device, a machine learning device, a substrate plating device, an information processing method, an inference method, and a machine learning method that can enable appropriate prediction of vibration characteristics of a paddle according to a motion status of a substrate plating device.

### SUMMARY

According to an embodiment of the disclosure, there is provided an information processing device including: an information acquiring part configured to acquire plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and an information generating part configured to generate agitating-motion paddle vibration information in response to the plating process information by inputting the plating process information acquired by the information acquiring part to a learning model which has learned a correlation between the plating process information and the agitating-motion paddle vibration information indicating vibration characteristics of the target paddle when only the agitating motion indicated by the target paddle motion information of the operational motion information included in the plating process information has been performed using machine learning.

According to an embodiment of the disclosure, there is provided an inference device including a memory and a processor. The processor performs: an information acquiring process of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and an inference process of inferring agitating-motion paddle vibration information indicating vibration characteristics of the target paddle when only the agitating motion indicated by the target paddle motion information of the operational motion information included in the plating process information has been performed when the plating process information is acquired in the information acquiring process.

According to an embodiment of the disclosure, there is provided a machine learning device including: a training data storage part configured to store a plurality of sets of training data including plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed and agitating-motion paddle vibration information indicating vibration characteristics of the target paddle when only the agitating motion indicated by the target paddle motion information of the operational motion information included in the plating process information has been performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; a machine learning part configured to cause a learning model to learn a correlation between the plating process information and the agitating-motion paddle vibration information through machine learning by inputting the plurality of sets of training data to the learning model; and a trained model storage part configured to store the learning model which has been caused to learn the correlation by the machine learning part.

According to an embodiment of the disclosure, there is provided a substrate plating device for performing the operational motions, the substrate plating device serving as one of: the information processing device described above; and the machine learning device described above.

According to an embodiment of the disclosure, there is provided an information processing method including: an information acquiring step of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and an information generating step of generating agitating-motion paddle vibration information in response to the plating process information by inputting the plating process information acquired in the information acquiring step to a learning model which has learned a correlation between the plating process information and the agitating-motion paddle vibration information indicating vibration characteristics of the target paddle when only the agitating motion indicated by the target paddle motion information of the operational motion information included in the plating process information has been performed using machine learning.

According to an embodiment of the disclosure, there is provided an inference method that is performed by an inference device including a memory and a processor. The processor performs: an information acquiring process of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and an inference process of inferring agitating-motion paddle vibration information indicating vibration characteristics of the target paddle when only the agitating motion indicated by the target paddle motion information of the operational motion information included in the plating process information has been performed when the plating process information is acquired in the information acquiring process.

According to an embodiment of the disclosure, there is provided a machine learning method including: a training data storing step of storing, in a training data storage part, a plurality of sets of training data including plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed and agitating-motion paddle vibration information indicating vibration characteristics of the target paddle when only the agitating motion indicated by the target paddle motion information of the operational motion information included in the plating process information has been performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; a machine learning step of causing a learning model to learn a correlation between the plating process information and the agitating-motion paddle vibration information through machine learning by inputting the plurality of sets of training data to the learning model; and a trained model storing step of storing the learning model which has been caused to learn the correlation in the machine learning step in a trained model storage part.

### BRIEF DESCRIPTION I/F THE DRAWINGS

FIG. 1 is an entire configuration diagram illustrating an example of a substrate plating system 1.

FIG. 2 is a plan view illustrating an example of a substrate plating device 2.

FIG. 3 is a longitudinal-sectional front view illustrating an example of a plating processing part 23.

FIG. 4 is a longitudinal-sectional side view illustrating an example of the plating processing part 23.

FIG. 5 is a longitudinal-sectional side view illustrating an example of a substrate holder carrying part 24.

FIG. 6 is a block diagram illustrating an example of the substrate plating device 2.

FIG. 7 is a hardware configuration diagram illustrating an example of a computer 900.

FIG. 8 is a block diagram illustrating an example of a machine learning device 3.

FIG. 9 is a diagram illustrating an example of a learning model 10 and training data 11.

FIG. 10 is a plan view illustrating an arrangement relationship between a target paddle and a target plating tank and a surrounding paddle and a surrounding plating tank.

FIG. 11 is a flowchart illustrating an example of a machine learning method that is performed by the machine learning device 3.

FIG. 12 is a flowchart (continued from FIG. 11) illustrating an example of the machine learning method that is performed by the machine learning device 3.

FIG. 13 is a block diagram illustrating an example of an information processing device 4.

FIG. 14 is a functional configuration diagram illustrating an example of the information processing device 4.

FIG. 15 is a flowchart illustrating an example of an information processing method that is performed by the information processing device 4.

### DESCRIPTION I/F THE EMBODIMENTS

With the information processing device according to an embodiment of the disclosure, since agitating-motion paddle vibration information indicating vibration characteristics of a target paddle when only the agitating motion is performed is generated by inputting the plating process information including the operational motion information indicating the operation motion performed by the substrate plating device and the operational-motion paddle vibration information indicating vibration characteristics of the target paddle when the operational motion is performed to the learning model, it is possible to appropriately predict vibration characteristics of the paddle according to the motion status of the substrate plating device.

Other purposes, configurations, and advantageous effects will be apparent from embodiments of the disclosure which will be described later.

Hereinafter, an embodiment of the disclosure will be described with reference to the accompanying drawings. In the following description, a range required for describing the disclosure will be schematically described, a range required for describing corresponding parts of the disclosure will be mainly described, and it is assumed that parts of which description is omitted are based on known techniques.

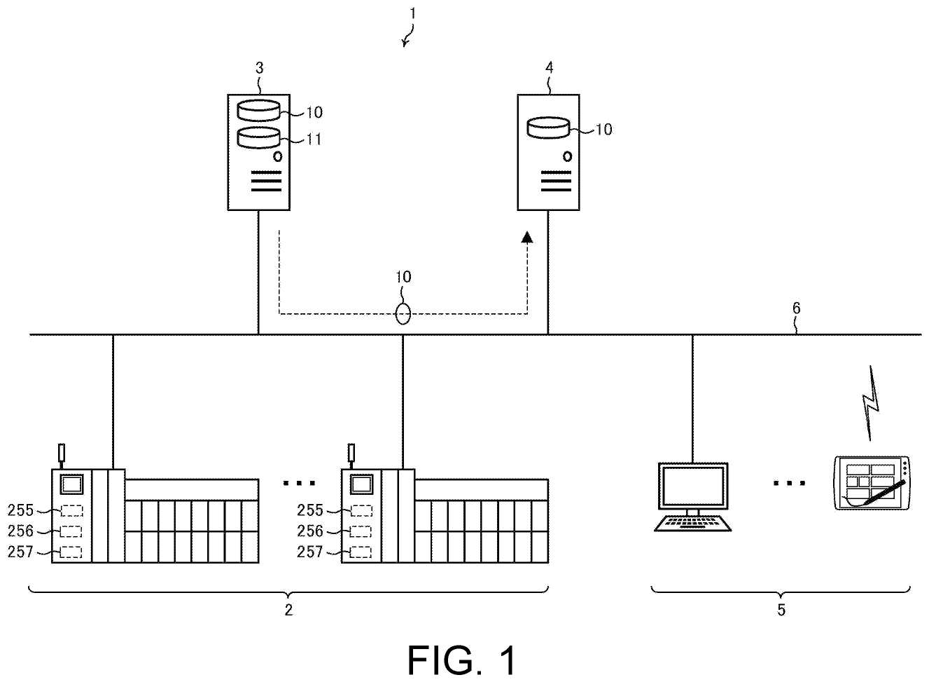

FIG. 1 is an entire configuration diagram illustrating an example of a substrate plating system 1. The substrate plating system 1 according to this embodiment serves as a system for performing process management of a plating process of forming a predetermined plating film on a surface of a substrate.

The substrate is, for example, a semiconductor substrate (a wafer), a glass substrate, or a printed board and is formed of, for example, a metallic material, a resin material, or a combined material thereof. The shape of the substrate may be circular or may be polygonal. In this embodiment, it is assumed that the substrate is a circular semiconductor substrate.

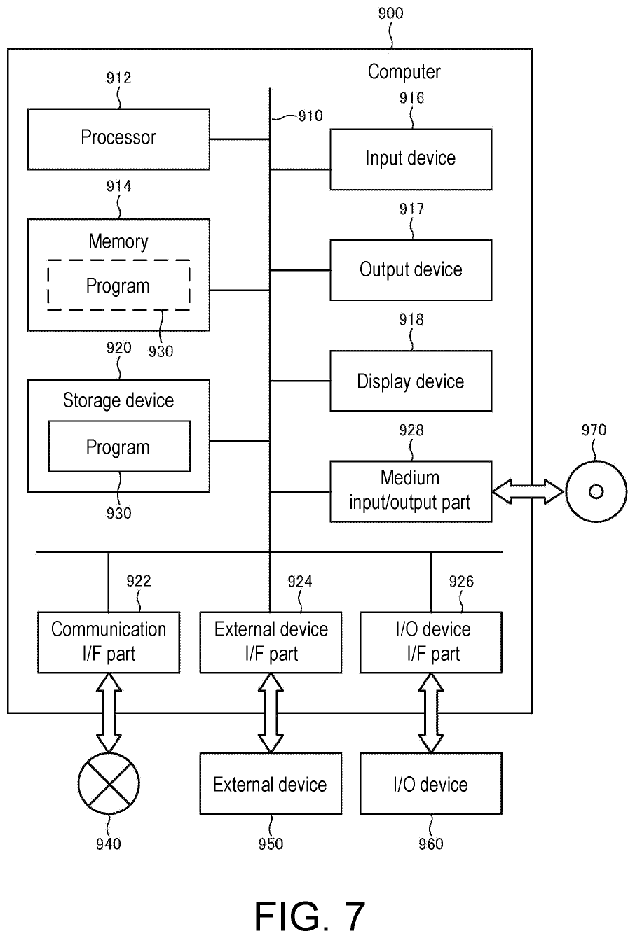

The substrate plating system 1 includes a substrate plating device 2, a machine learning device 3, an information processing device 4, and a user terminal device 5 as major components thereof. The devices 2 to 5 include, for example, a general-purpose or dedicated computer (see FIG. 7 which will be described later) and are connected to a wired or wireless network 6 and configured to transmit and receive various types of data (transmission and reception of some data is indicated by a dotted arrow in FIG. 1). The number of devices 2 to 5 or a connection configuration to the network 6 is not limited to the example illustrated in FIG. 1 and may be appropriately modified.

The substrate plating device 2 is, for example, a device including constituent parts (details of which will be described later) and performing loading, carrying, plating processing, unloading, and the like in parallel as a series of operational motions for a plurality of substrates. Here, the substrate plating device 2 controls operational motions of the constituent parts with reference to device setting information 255 including a plurality of device parameters set for the constituent parts and substrate recipe information 256 for determining operational motions of a plating process or the like. In the plating process, a plating solution used for plating of substrates is stored in a plating tank and is agitated by a paddle, whereby the plating process is performed. The plating solution may be of an arbitrary type and is appropriately selected, for example, according to materials or applications of substrates and a type of a plating film.

The substrate plating device 2 generates various types of report information 257 according to operational motions of the constituent parts and transmits the generated report information to, for example, the machine learning device 3, the information processing device 4, and the user terminal device 5. The report information 257 includes, for example, motion information when operational motions have been performed by the substrate plating device 2, event information detected in the substrate plating device 2, and operation information of a user (such as an operator, a production manager, or a maintenance manager) on the substrate plating device 2. A unique device ID is assigned to the substrate plating device 2 and a unique substrate ID is assigned to a substrate, whereby the various types of report information 257 are managed.

The machine learning device 3 operates as a main unit in a learning phase of machine learning, acquires training data 11, for example, based on the report information 257 or the like generated by the substrate plating device 2 or a testing device (not illustrated) that can reproduce a plating process which is performed through operational motions of the substrate plating device 2, and performs machine learning of a learning model 10. The trained learning model 10 is provided to the information processing device 4 via the network 6, a recording medium, or the like.

The information processing device 4 operates as a main unit in an inference phase of machine learning, acquires motion information or the like, for example, from the substrate plating device 2, predicts (infers) vibration characteristics of a paddle using the learning model 10 generated by the machine learning device 3, and determines occurrence of an abnormality in the paddle based on the predicted vibration characteristics of the paddle. The information processing device 4 transmits agitating-motion paddle vibration information indicating a result of inference of vibration characteristics of the paddle or paddle abnormality occurrence information indicating a result of determination of occurrence of an abnormality in the paddle to the substrate plating device 2, the user terminal device 5, and the like. The information processing device 4 may generate the agitating-motion paddle vibration information or the paddle abnormality occurrence information while the operational motions are actually being performed or after the operational motions have been performed.

The user terminal device 5 is a terminal device that is used by a user and may be a stationary device or a portable device. The user terminal device 5 receives various types of input operations, for example, via a display screen of an application program or a web browser and displays various types of information (for example, a notification of an event, the device setting information 255, the substrate recipe information 256, the report information 257, the agitating-motion paddle vibration information, and the paddle abnormality occurrence information) on the display screen.

(Substrate Plating Device 2)

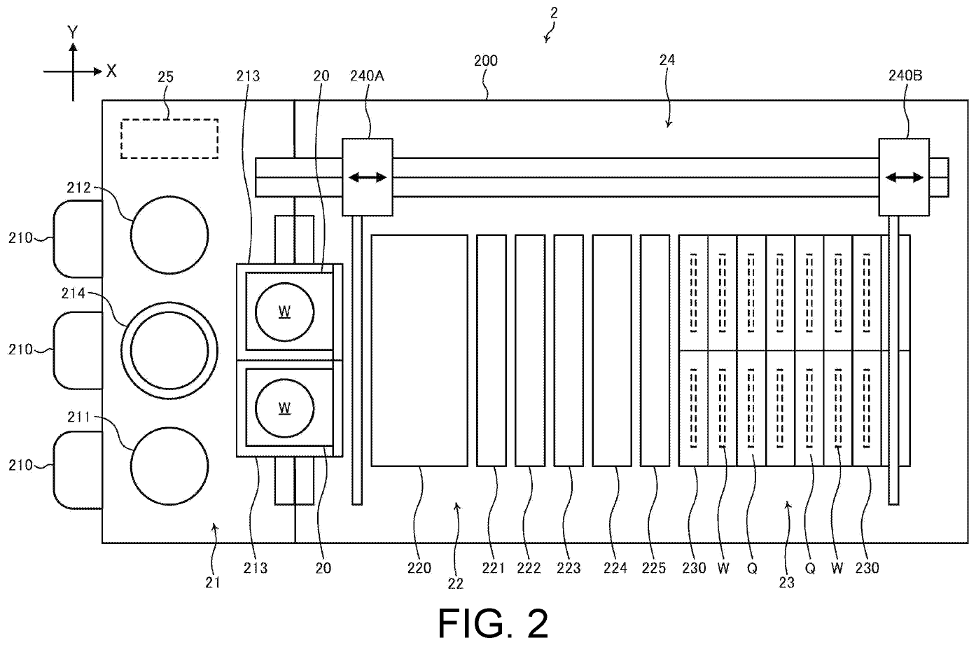

FIG. 2 is a plan view illustrating an example of the substrate plating device 2. The substrate plating device 2 includes a housing 200 having a substantially rectangular shape in a plan view and includes a loading/unloading part 21 loading a substrate W to a substrate holder 20 and unloading a substrate W from a substrate holder 20, a pre-processing/post-processing part 22 performing pre-processing and post-processing of the plating process, a plating processing part 23 performing the plating process on the substrate W, a substrate holder carrying part 24 carrying a substrate holder 20 (including a substrate holder 20 holding (loading) a substrate W and a substrate holder 20 not holding a substrate) between the loading/unloading part 21, the pre-processing/post-processing part 22, and the plating processing part 23, and a control unit 25 controlling the constituent parts 21 to 24 of the substrate plating device 2 in the housing 200 thereof.

(Loading/Unloading Part 21)

The loading/unloading part 21 includes a plurality of loading ports 210 on which a substrate cassette (not illustrated) containing a plurality of substrates W can be mounted, an aligner 211 aligning positions of an orientation flat, a notch, or the like of the substrates W to a predetermined direction, a rinse-spin drier 212 drying the substrates W subjected to the plating process through fast rotation, a clamping station 213 having a substrate holder 20 mounted thereon and clamping and unclamping the substrates W to and from the substrate holder 20, and a loading robot 214 performing carrying and receiving of the substrates W between the loading ports 210, the aligner 211, the rinse-spin drier 212, and the clamping station 213. The aligner 211, the rinse-spin drier 212, and the clamping station 213 are disposed, for example, centered on the loading robot 214.

(Pre-Processing/Post-Processing Part 22)

The pre-processing/post-processing part 22 includes a stocker 220 having a substrate holder 20 temporarily mounted thereon and storing the substrate holder, a pre-wetting tank 221 immersing a substrate W in pure water, a pre-soak tank 222 removing an oxide film formed on the surface of the substrate W by etching using an organic acid solution, a first cleaning tank 223 cleaning the pre-soaked substrate W using a cleaning solution, a blow tank 224 performing liquid draining of the cleaned substrate W, and a second cleaning tank 225 cleaning the substrate W subjected to the plating process using a cleaning solution, which are arranged, for example, sequentially in the X direction in FIG. 2.

(Plating Processing Part 23)

The plating processing part 23 immerses substrates W held by a substrate holder 20 in a plating solution Q stored in a plating tank 230 and performs a plating process on the surfaces of the substrates W, for example, using copper, gold, silver, solder, or nickel.

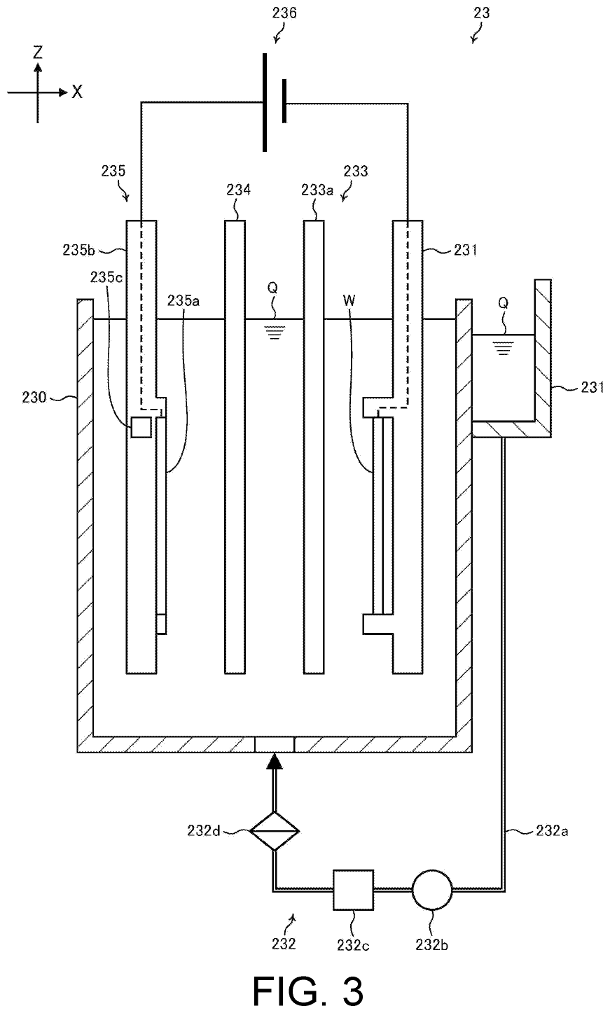

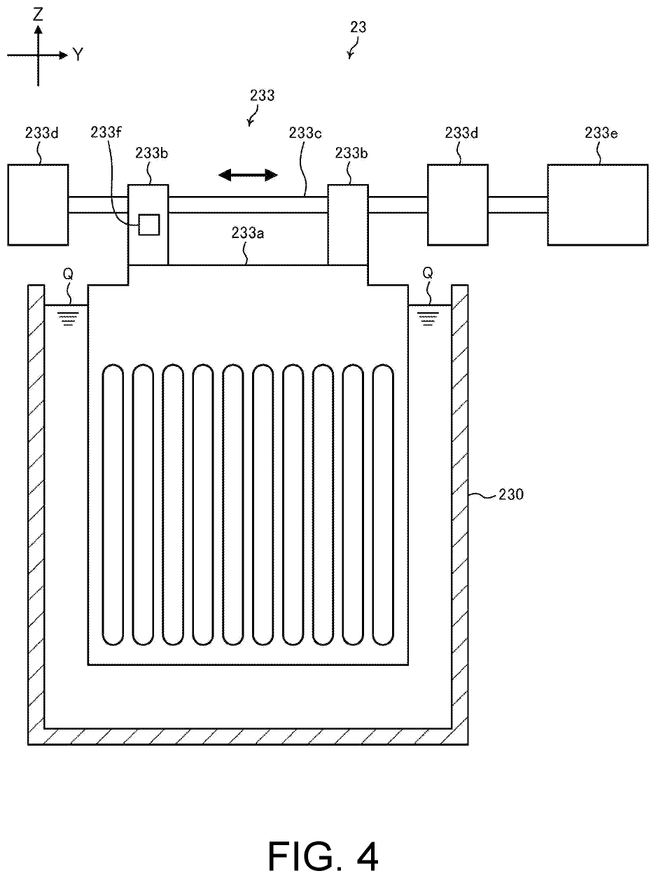

FIG. 3 is a longitudinal front view illustrating an example of the plating processing part 23. FIG. 4 is a longitudinal side view illustrating an example of the plating processing part 23. The plating processing part 23 includes a plurality of plating tanks 230 storing a plating solution Q used for plating of a substrate W, an overflow tank 231 disposed to surround the plurality of plating tanks 230, and a plating solution circulation part 232 circulating the plating solution Q from the overflow tank 231 to the plating tank 230. In this embodiment, the plating processing part 23 includes a total of 16 plating tanks 230 in eight lines in the X direction and 2 lines in the Y direction in FIG. 2 as the plurality of plating tanks 230, and the plating process is performed in parallel in the 16 plating tanks 230.

The plating processing part 23 includes a plating solution agitating part 233 agitating the plating solution Q using a paddle 233a, a regulation plate 234 formed of a dielectric material to make a potential distribution in a substrate W uniform, an anode part 235 including an anode electrode 235a, and a plating power supply circuit 236 electrically connected to the substrate W and the anode electrode 235a as constituent parts installed in each of the plurality of plating tanks 230.

The plating solution circulation part 232 includes a plating solution circulation channel 232a connecting the plating tank 230 to the overflow tank 231, a plating solution circulation pump 232b circulating the plating solution Q, a thermostat 232c adjusting the temperature of the plating solution Q, and a filter 232d removing trimmings included in the plating solution Q. The number of plating solution circulation pumps 232b may be one or two or more, and, for example, the plating solution circulation pump 232b may be provided to be shared by the plurality of plating tanks 230 or may be provided individually for each of the plurality of plating tanks 230.

An operation of supplying the plating solution Q using the plating solution circulation part 232 is performed in accordance with command values (for example, an amount of liquid of the plating solution Q stored in the plating tank 230, a motion timing of the plating solution circulation pump 232b, and a rotation speed of the plating solution circulation pump 232b) from the control unit 25.

The plating solution agitating part 233 includes, for example, a paddle 233a formed of a plate-shaped member having a plurality of through-holes, a paddle holder 233b holding the paddle 233a, a shaft 233c supporting the paddle holder 233b, a shaft support part 233d slidably supporting the paddle 233a, a paddle moving mechanism part 233e connected to an end of the shaft 233c to move the paddle 233a, and a paddle vibration sensor 233f detecting vibration generated in the paddle 233a when an agitating motion is performed.

The paddle 233a is formed of a metal material such as titanium such that the plating solution Q passes through lattice-shaped gaps (through-holes). The shape or the material of the paddle 233a may be appropriately modified.

The paddle moving mechanism part 233e operates the paddle 233a, for example, such that the paddle 233a reciprocates in parallel to the surface of a substrate W. Although a specific configuration of the paddle moving mechanism part 233e is not illustrated in FIG. 4, the paddle moving mechanism part 233e has, for example, a configuration in which a driving force generation module such as a rotation motor, a linear motor, and an air-driven actuator, a driving force transmission mechanism such as a crank, a linear guide, a ball screw, a gear, a belt, a coupling, and a bearing, and a sensor such as an encoder sensor, a linear sensor, a limit sensor, and a torque sensor are appropriately combined.

The paddle vibration sensor 233f is attached to, for example, the paddle 233a, the paddle holder 233b, the shaft 233c, or the shaft support part 233d. The paddle vibration sensor 233f includes, for example, a displacement sensor, an acceleration sensor, or an angular velocity sensor and may have one of one axis, two axes, and three axes.

The agitating motion of the paddle 233a which is performed by the plating solution agitating part 233 is performed in accordance with command values (for example, a motion speed, a motion frequency, and a motion stroke of the paddle 233a) from the control unit 25.

The anode part 235 includes, for example, an anode electrode 235a having substantially the same shape (a circular shape in this embodiment) as the substrate W, an anode holder 235b detachably holding the anode electrode 235a, and an anode weight sensor 235c including a load cell capable of detecting the weight of the anode electrode 235a.

When a plating process is performed on a plating tank 230, a substrate holder 20 holding a substrate W to be processed is disposed in the plating tank 230 by a second carrier machine 240B. At this time, the substrate holder 20 is separated from the second carrier machine 240B and is supported at an upper edge of the plating tank 230. The paddle 233a, the regulation plate 234, and the anode electrode 235a are placed sequentially in the plating tank 230 such that they face the substrate W as illustrated in FIG. 3. Then, the substrate W and the anode electrode 235a are electrically connected via the plating power supply circuit 236 and a current flows between the substrate W and the anode electrode 235a, whereby a plating film is formed on the surface of the substrate W.

(Substrate Holder Carrying Part 24)

The substrate holder carrying part 24 includes a first carrier machine 240A and a second carrier machine 240B as two carrier machines as illustrated in FIG. 2. The first carrier machine 240A is configured to carry a substrate W between the clamping station 213, the stocker 220, the pre-wetting tank 221, a pre-soak tank 222, the first cleaning tank 223, and the blow tank 224. The second carrier machine 240B is configured to carry a substrate holder 20 between the first cleaning tank 223, the blow tank 224, the second cleaning tank 225, and the plating tank 230.

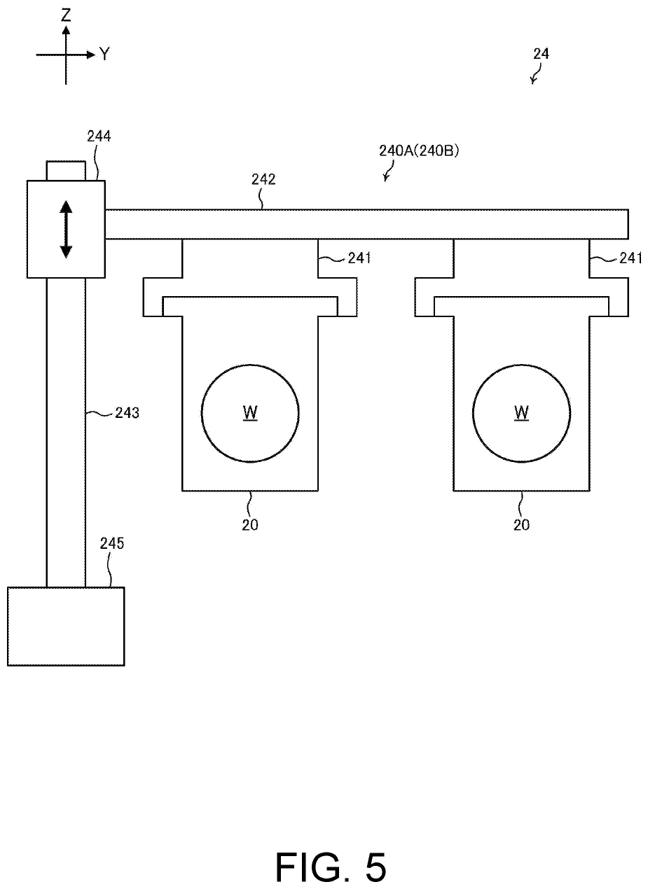

FIG. 5 is a longitudinal side view illustrating an example of the substrate holder carrying part 24. Each of the first and second carrier machines 240A and 240B includes two substrate holder support parts 241 detachably holding a substrate holder 20, a support arm 242 holding the two substrate holder support parts 241, a support beam 243 supporting the support arm 242, a vertical movement mechanism part 244 vertically moving the support arm 242 in the Z direction in FIG. 5, and a horizontal movement mechanism part 245 horizontally moving the support beam 243 in the X direction in FIG. 2.

Although specific configurations of the vertical movement mechanism part 244 and the horizontal movement mechanism part 245 are not illustrated in FIG. 5, similarly to the paddle moving mechanism part 233e, each thereof has a configuration in which a driving force generation module such as a rotation motor, a linear motor, and an air-driven actuator, a driving force transmission mechanism such as a crank, a linear guide, a ball screw, a gear, a belt, a coupling, and a bearing, and a sensor such as an encoder sensor, a linear sensor, a limit sensor, and a torque sensor are appropriately combined.

A motion of carrying a substrate W which is performed by the substrate holder carrying part 24 is performed in accordance with command values (for example, motion timings and motion speeds of the first and second carrier machines 240A and 240B) from the control unit 25. That is, the first and second carrier machines 240A and 240B in the substrate holder carrying part 24 carries a substrate holder 20 to a predetermined movement position from time to time according to a motion status of the loading/unloading part 21, a motion status of the pre-processing/post-processing part 22, and a motion status of the plating processing part 23 (start and end of a plating process in each plating tank 230).

The configurations of the constituent parts 21 to 24 of the substrate plating device 2 may be appropriately modified, and the arrangement and numbers of the constituent parts 21 to 24 may be appropriately modified. For example, in the pre-processing/post-processing part 22, the arrangement order of the stocker 220, the pre-wetting tank 221, the pre-soak tank 222, the first cleaning tank 223, the blow tank 224, the second cleaning tank 225, and the plating processing part 23 may be appropriately modified. The plating processing part 23 may include the plating tanks 230 and the paddles 233a of the number different from that in FIG. 2 or may include one plating tank 230 and one paddle 233a. The substrate holder carrying part 24 may include three or more carrier machines or include one carrier machine, and the range in which the carrier machine carries a substrate holder 20 can be appropriately modified.

(Control Unit 25)

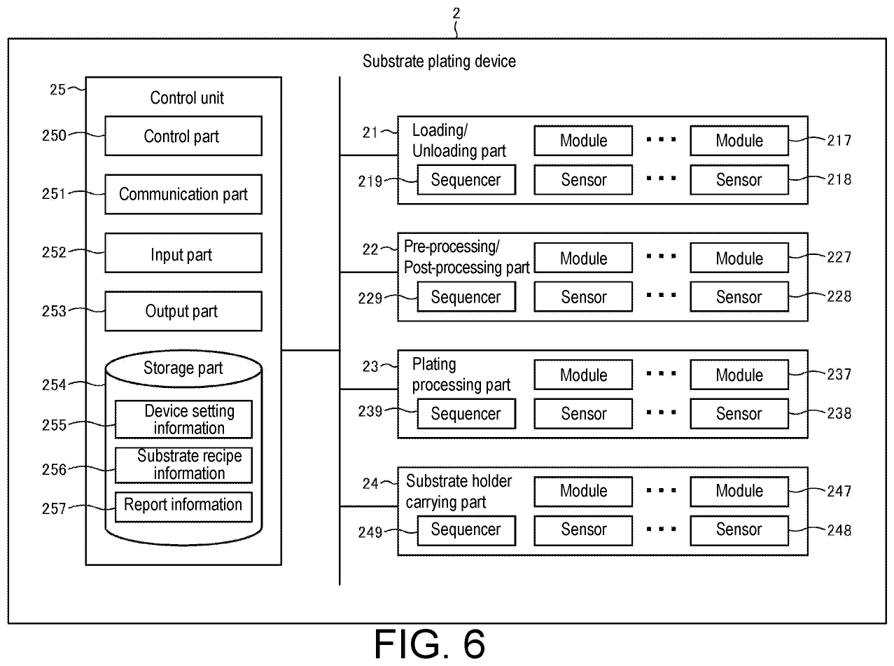

FIG. 6 is a block diagram illustrating an example of the substrate plating device 2. The control unit 25 is electrically connected to the constituent parts 21 to 24 of the substrate plating device 2 and serves as a control part comprehensively controlling the constituent parts 21 to 24. In the following description, control systems (modules, sensors, and sequencers) of the plating processing part 23 and the substrate holder carrying part 24 will be exemplified, but the basic configurations and functions of the loading/unloading part 21 and the pre-processing/post-processing part 22 are the same and thus description thereof will be omitted.

The plating processing part 23 includes a plurality of modules 237 (for example, the plating tank 230, the plating solution circulation pump 232b, the thermostat 232c, the paddle moving mechanism part 233e, the anode holder 235b, and the plating power supply circuit 236) of the plating processing part 23, a plurality of sensors 238 detecting data (detection values) required for controlling the modules 237, and the sequencer 239 controlling the operations of the modules 237 based on detection values of the sensors 238.

Examples of the sensors 238 of the plating processing part 23 include a sensor detecting an amount of liquid of the plating solution Q in the plating tank 230, a sensor detecting a temperature of the plating solution Q in the plating tank 230, a sensor detecting a motion status indicating whether the plating solution circulation pump 232b is operating, a sensor detecting a rotation speed of the plating solution circulation pump 232b, a sensor detecting a motion status indicating whether the thermostat 232c is operating, a sensor detecting a motion speed, a motion frequency, and a motion stroke of the paddle moving mechanism part 233e which can be converted to the motion speed, the motion frequency, and the motion stroke of the paddle 233a, a sensor detecting vibration of the paddle 233a (a paddle vibration sensor 2331), a sensor detecting a weight of the anode electrode 235a (an anode weight sensor 235c), and a sensor detecting a source power (a current and a voltage) at the time of performing the plating process.

The substrate holder carrying part 24 includes a plurality of modules 247 (for example, the vertical movement mechanism part 244 and the horizontal movement mechanism part 245) of the substrate holder carrying part 24, a plurality of sensors 248 detecting data (detection values) required for controlling the modules 247, and a sequencer 249 controlling operations of the modules 247 based on detection values from the sensors 248.

Examples of the sensors 248 of the substrate holder carrying part 24 include a sensor detecting a motion status indicating whether the first and second carrier machines 240A and 240B are operating, a sensor detecting motion speeds of the vertical movement mechanism part 244 and the horizontal movement mechanism part 245, and a sensor detecting position coordinates of the vertical movement mechanism part 244 and the horizontal movement mechanism part 245 which can be converted to a position or a distance of the first and second carrier machines 240A and 240B relative to the paddle 233a.

The control unit 25 includes a control part 250, a communication part 251, an input part 252, an output part 253, and a storage part 254. The control unit 25 is constituted by, for example, a general-purpose or dedicated computer (see FIG. 7 which will be described later).

The communication part 251 is connected to the network 6 and serves as a communication interface transmitting and receiving various types of data. The input part 252 receives various input operations, and the output part 253 serves as a user interface by outputting various types of information using a display screen, a signal tower lamp, or buzzer sound.

The storage part 254 stores various programs (such as an operating system (OS), an application program, and a web browser) or data (such as the device setting information 255, the substrate recipe information 256, and the report information 257) used for operation of the substrate plating device 2. The device setting information 255 and the substrate recipe information 256 are data which can be edited by a user using the display screen.

The control part 250 performs a series of operational motions such as loading, carrying, plating, and unloading by acquiring detection values from a plurality of sensors 218, 228, 238, and 248 (hereinafter referred to as a “sensor group”) via a plurality of sequencers 219, 229, 239, and 249 (hereinafter referred to as a “sequencer group”) and cooperatively operating a plurality of modules 217, 227, 237, and 247 (hereinafter referred to as a “module group”). The sequence group may be omitted. In this case, the function of the sequencer group can be realized by the control part 250.

(Hardware Configurations of Devices)

FIG. 7 is a hardware configuration diagram illustrating an example of a computer 900. Each of the control unit 25, the machine learning device 3, the information processing device 4, and the user terminal device 5 of the substrate plating device 2 is constituted by a general-purpose or dedicated computer 900.

As illustrated in FIG. 7, the computer 900 includes a path 910, a processor 912, a memory 914, an input device 916, an output device 917, a display device 918, a storage device 920, a communication interface (I/F) part 922, an external device I/F part 924, an input/output (I/O) device I/F part 926, and a medium input/output part 928 as major components. These components may be appropriately omitted according to applications for which the computer 900 is used.

The processor 912 is constituted by one or more arithmetic processing devices (such as a central processing unit (CPU), a micro-processing unit (MPU), a digital signal processor (DSP), or a graphics processing unit (GPU)) and serves as a control part comprehensively controlling the computer 900 as a whole. The memory 914 stores various types of data and programs 930 and is constituted by, for example, a volatile memory (such as a DRAM and an SRAM) serving as a main memory, a nonvolatile memory (such as a ROM), and a flash memory.

The input device 916 is constituted by, for example, a keyboard, a mouse, ten keys, or an electronic pen and serves as an input part. The output device 917 includes, for example, a sound (speech) output device and a vibration device and serves as an output part. The display device 918 is constituted by, for example, a liquid crystal display, an organic EL display, an electronic paper, or a projector and serves as an output part. The input device 916 and the display device 918 may be configured as a unified body such as a touch panel display. The storage device 920 is constituted by, for example, an HDD or a solid state drive (SSD) and serves as a storage part. The storage device 920 stores various types of data required to execute the operating system or programs 930.

The communication I/F part 922 is connected to a network 940 such as the Internet or an intranet (which may be the same as the network 6 in FIG. 1) in a wired or wireless manner and serves as a communication part performing transmission and reception of data to and from another computer in accordance with a predetermined communication standard. The external device I/F part 924 is connected to an external device 950 such as a camera, a printer, a scanner, or a reader writer in a wired or wireless manner and serves as a communication part performing transmission and reception of data to and from the external device 950 in accordance with a predetermined communication standard. The I/O device I/F part 926 is connected to an I/O device 960 such as various sensors and actuators and serves as a communication part performing transmission and reception of various signals such as detection signals from the sensors or a control signal for the actuators and data to and from the I/O device 960. The medium input/output part 928 is constituted by, for example, a drive device such as a DVD drive or a CD drive and performs reading and writing of data from and to a medium 970 such as a DVD or a CD (a non-transitory storage medium).

In the computer 900 having the aforementioned configuration, the processor 912 calls and executes the programs 930 stored in the storage device 920 to the memory 914 and controls the constituent parts of the computer 900 via the path 910. The programs 930 may be stored in the memory 914 instead of the storage device 920. The programs 930 may be recorded on the medium 970 in an installable file format or an executable file format and provided to the computer 900 via the medium input/output part 928. The programs 930 may be provided to the computer 900 by being downloaded via the network 940 by the communication I/F part 922. The computer 900 may realize various functions, which are realized by causing the processor 912 to execute the programs 930, for example, using hardware such as an FPGA or an ASIC.

The computer 900 is constituted by, for example, a stationary computer or a portable computer and is an arbitrary type of electronic device. The computer 900 may be a client computer or may be server computer or a cloud computer. The computer 900 may be applied to a device other than the devices 2 to 5.

(Machine Learning Device 3)

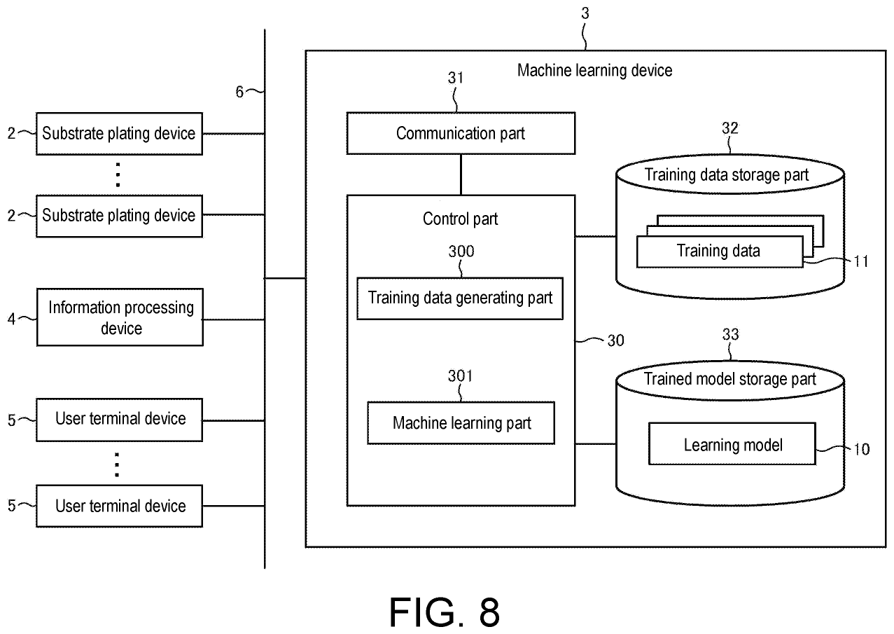

FIG. 8 is a block diagram illustrating an example of the machine learning device 3. The machine learning device 3 includes a control part 30, a communication part 31, a training data storage part 32, and a trained model storage part 33.

The control part 30 serves as a training data generating part 300 and a machine learning part 301. The communication part 31 is connected to an external device (for example, the substrate plating device 2, the information processing device 4, the user terminal device 5, and a testing device (not illustrated)) via the network 6 and serves as a communication interface transmitting and receiving various types of data.

The training data generating part 300 is connected to an external device via the communication part 31 and the network 6 and generates training data 11 including plating process information which is input data (an explanatory variable) and agitating-motion paddle vibration information which is output data (an objective variable). The training data generating part 300 generates the training data 11, for example, by acquiring report information generated by the substrate plating device 2 or a text machine or receiving a user's input operation from the user terminal device 5 according to necessity.

The training data storage part 32 is a database storing a plurality of sets of training data 11 acquired from the training data generating part 300. A specific configuration of the database constituting the training data storage part 32 can be appropriately designed.

The machine learning part 301 performs machine learning using the plurality of sets of training data 11 stored in the training data storage part 32. The machine learning part 301 performs supervised learning as a method of the machine learning, the training data 11 is used as training data, verification data, and test data in the supervised learning, and the agitating-motion paddle vibration information which is the output data of the training data 11 is used as answer data in the supervised learning. That is, the machine learning part 301 generates a trained learning model 10 by inputting the plurality of sets of training data 11 to the learning model 10 and causing the learning model 10 to learn a correlation between the plating process information and the agitating-motion paddle vibration information of the training data 11.

The trained model storage part 33 is a database storing the trained learning model 10 (specifically an adjusted weighting parameter group) generated by the machine learning part 301. The trained learning model 10 stored in the trained model storage part 33 is provided to an actual system (for example, the substrate plating device 2 and the information processing device 4) via the network 6, a recording medium, or the like. The training data storage part 32 and the trained model storage part 33 are illustrated as separate storage parts in FIG. 8, but they may be configured as a single storage part.

The number of learning models 10 stored in the trained model storage part 33 is not limited to 1, and a plurality of learning models having different conditions such as a method of the machine learning, a mechanism difference of the plating processing part 23, a mechanism difference of the substrate holder carrying part 24, a data type included in the plating process information, and a data type included in the agitating-motion paddle vibration information may be stored. In this case, a plurality of types of training data having data configurations corresponding to the plurality of learning models having different conditions can be stored in the training data storage part 32.

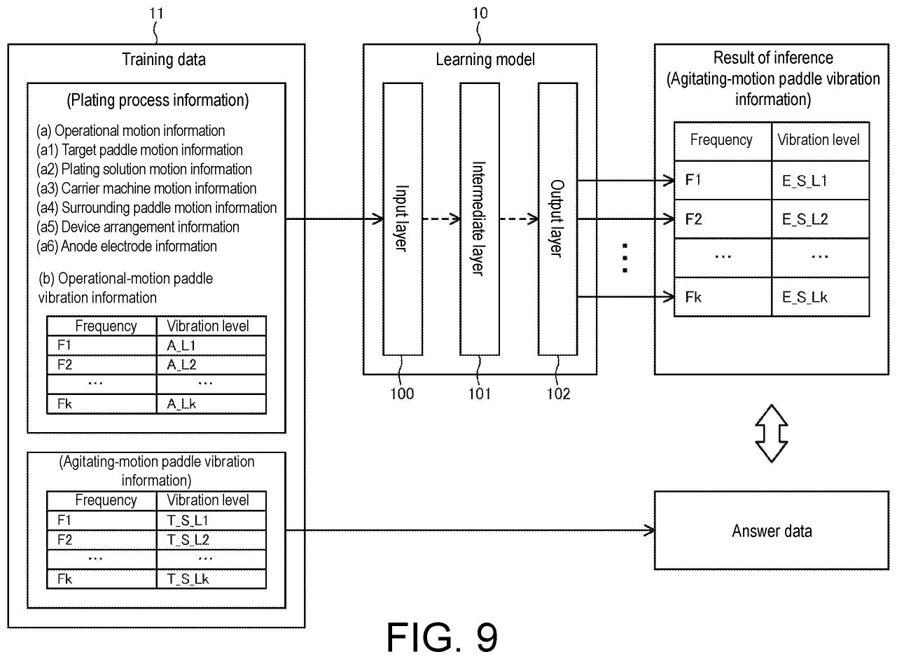

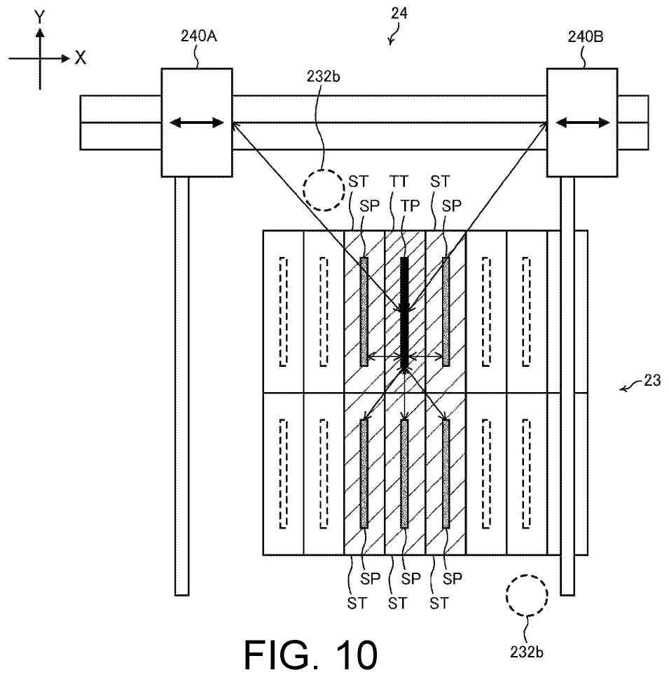

FIG. 9 is a diagram illustrating an example of the learning model 10 and the training data 11. FIG. 10 is a plan view illustrating an arrangement relationship between a target paddle and a target plating tank a surrounding paddle and a surrounding plating tank. The training data 11 used for machine learning of the learning model 10 includes plating process information which is input data and agitating-motion paddle vibration information which is output data.

When the substrate plating device 2 includes a plurality of (specifically 16) plating tanks 230 and paddles 233a as in this embodiment, the plating process information and the agitating-motion paddle vibration information are defined based on the assumption that one paddle 233a of the plurality of paddles 233a is selected as a paddle 233a to be processed (a target paddle TP) and the substrate plating device 2 includes a target plating tank TT corresponding to the plating tank 230 in which the target paddle TP is provided and surrounding plating tanks ST corresponding to the plating tanks 230 arranged around the target plating tank TT as the plurality of plating tanks 230 and includes the target paddle TP and surrounding paddles SP corresponding to the paddles 233a provided in the surrounding plating tanks ST as the plurality of paddles 233a. As illustrated in FIG. 10, the plurality of surrounding paddles SP and the plurality of plating tanks ST may include the surrounding paddle SP and the surrounding plating tank ST arranged in the vicinity the target paddle TP and the target plating tank TT or may include all the surrounding paddles SP and all the surrounding plating tanks ST. When the substrate plating device 2 includes one plating tank 230 and one paddle 233a, the plating process information and the agitating-motion paddle vibration information can be defined such that they are used as the target paddle TP and the target plating tank TT and no surrounding paddle SP and no surrounding plating tank ST are provided.

The plating process information which is input data includes operational motion information and operational-motion paddle vibration information.

The operational motion information includes target paddle motion information indicating an agitating motion of the target paddle TP, plating solution motion information indicating a motion of supplying a plating solution Q to the plating tank 230, and carrier machine motion information indicating a motion of carrying a substrate W.

The target paddle motion information includes at least one of a motion speed of the target paddle TP, a motion frequency of the target paddle TP, and a motion stroke of the target paddle TP. The motion speed of a paddle 233a is determined, for example, by a moving speed of the paddle 233a by the paddle moving mechanism part 233e, a rotation speed of the rotation motor, or a driving speed of the linear motor. The motion frequency of the paddle 233a is determined, for example, by the number of reciprocations per unit time when the paddle 233a is made to reciprocate by the paddle moving mechanism part 233e. The motion stroke of the paddle 233a is determined, for example, by an amount of movement when the paddle 233a is made to reciprocate by the paddle moving mechanism part 233e.

The plating solution motion information includes at least one of an amount of liquid of the plating solution Q stored in the plating tank 230, a motion status indicating whether the plating solution circulation pump 232b is operating, and a rotation speed of the plating solution circulation pump 232b. The amount of liquid of the plating solution Q includes at least an amount of liquid in the target plating tank TT and may further include an amount of liquid in the surrounding plating tank ST. When the plating solution circulation part 232 includes a plurality of plating solution circulation pumps 232b, the plating solution motion information may include a motion status and a rotation speed in each of the plurality of plating solution circulation pumps 232b.

Since the amount of liquid of the plating solution Q or the motion of the plating solution circulation pump 232b affects an agitation state of the plating solution Q and vibration due to the motion (pump vibration) propagates to the target plating tank TT or the plating solution agitating part 233, it is estimated the amount of liquid or the motion much affects the agitating motion of the target paddle TP or the detection value of the paddle vibration sensor 233f. Accordingly, when the plating process information includes the plating solution motion information, the learning model 10 can be made to learn an influence of the pump vibration on the vibration characteristics of the target paddle TP.

The carrier machine motion information includes at least one of a motion status indicating whether the first and second carrier machines 240A and 240B are operating, motion speeds of the first and second carrier machines 240A and 240B, positions of the first and second carrier machines 240A and 240B relative to the target paddle TP, and distances between the target paddle TP and the first and second carrier machines 240A and 240B.

Since vibration due to the motions of the first and second carrier machines 240A and 240B (carrier machine vibration) propagates to the target plating tank TT or the plating solution agitating part 233, it is estimated that the motions of the first and second carrier machines 240A and 240B much affect the agitating motion of the target paddle TP and the detection value of the paddle vibration sensor 233f. Since attenuation of the carrier machine vibration decreases as the positions (distances) of the first and second carrier machines 240A and 240B relative to (from) the target paddle TP decreases, it is estimated that the agitating motion of the target paddle TP or the detection value of the paddle vibration sensor 233f are much affected. Since the frequency or vibration of the carrier machine vibration varies depending on the motion speeds of the first and second carrier machines 240A and 240B, it is estimated that a degree of interference with vibration generated in the target paddle TP varies. Accordingly, when the plating process information includes the carrier machine motion information, the learning model 10 can be made to learn an influence of the carrier machine vibration on the vibration characteristics of the target paddle TP.

The operational motion information may further include surrounding paddle motion information indicating the agitating motion of a surrounding paddle SP as illustrated in FIG. 9. The surrounding paddle motion information includes at least one of a motion status indicating whether the surrounding paddle SP is operating, a motion speed of the surrounding paddle SP, a motion frequency of the surrounding paddle SP, a motion stroke of the surrounding paddle SP, and a phase difference between the target paddle TP and the surrounding paddle SP. The phase difference is a difference in phase of the surrounding paddle SP from the target paddle TP when the target paddle TP and the surrounding paddle SP reciprocate periodically, and there is no phase difference when the target paddle TP and the surrounding paddle SP are synchronized. When the plating processing part 23 includes a plurality of (15 in this embodiment) surrounding paddle SP, the surrounding paddle motion information includes the motion status, the motion speed, the motion frequency, the motion stroke, and the phase difference in each of the plurality of surrounding paddles SP. Here, the plurality of surrounding paddles SP may include only the surrounding paddles SP disposed around the target paddle TP as illustrated in FIG. 10 or may include all the surrounding paddles SP.

Since vibration due to the motion of the surrounding paddle SP (surrounding paddle vibration) propagates to the target plating tank TT or the plating solution agitating part 233, it is estimated that the motion of the surrounding paddle SP much affects the agitating motion of the target paddle TP or the detection value of the paddle vibration sensor 233f. Regarding the relationship between the motion of the target paddle TP and the motion of the surrounding paddle SP, it is estimated that a vibration waveform of the target paddle TP is amplified by the vibration of the surrounding paddles when the phase difference is small to such an extent that the motion speeds thereof are the same, and the vibration waveform of the target paddle TP is modulated or attenuated by vibration of the surrounding paddles when the phase difference is large to such an extent that the motion speeds thereof are the same, and the vibration waveform of the target paddle TP interferes with the vibration of the surrounding paddles when the motion speeds thereof are different. Accordingly, when the plating process information includes the surrounding paddle motion information, the learning model 10 can be made to learn an influence of the vibration of the surrounding paddles on the vibration characteristics of the target paddle TP.

The operational motion information may further include device arrangement information on the arrangement of the plating tanks 230 and the paddles 233a as illustrated in FIG. 9. The device arrangement information includes at least one of a position of a surrounding paddle SP relative to the target paddle TP, a distance between the target paddle TP and the surrounding paddle SP, a position of a surrounding plating tank ST relative to the target plating tank TT, and a distance between the target plating tank TT and the surrounding plating tank ST. The device arrangement information includes the position and the distance in each of a plurality of (15 in this embodiment) surrounding paddles SP when the plating processing part 23 includes the plurality of surrounding paddles SP and includes the position and the distance in each of a plurality of (15 in this embodiment) surrounding plating tanks ST when the plating processing part 23 includes the plurality of surrounding plating tanks ST. Here, the plurality of surrounding paddles SP and the plurality of surrounding plating tanks ST may include only the surrounding paddles SP and the surrounding plating tanks ST disposed in the vicinity of the target paddle TP and the target plating tank TT as illustrated in FIG. 10 or may include all the surrounding paddles SP and all the surrounding plating tanks ST.

As described above, it is estimated that the motions of the surrounding paddles SP much affect the agitating motion of the target paddle TP or the detection value of the paddle vibration sensor 233f. At this time, it is estimated that the agitating motion of the target paddle TP or the detection value of the paddle vibration sensor 233f is more affected as the position of the surrounding paddle SP becomes closer to the target paddle TP (as the distance therebetween decreases) or as the position of the surrounding plating tank ST becomes closer to the target plating tank TT (as the distance therebetween decreases). Accordingly, when the plating process information includes the device arrangement information, the learning model 10 can be made to learn an influence of the vibration of the surrounding paddles on the vibration characteristics of the target paddle TP.

The operational motion information may further include anode electrode information on the anode electrode 235a provided in a plating tank 230 as illustrated in FIG. 9. The anode electrode information includes at least a weight of the anode electrode 235a. The weight of the anode electrode 235a includes at least the weight of the anode electrode 235a provided in the target plating tank TT and may further include the weights of the anode electrodes 235a provided in the surrounding plating tanks ST.

Since the anode electrode 235a is consumed slowly while the plating process is being performed and is replaced with a new product when a predetermined degree of consumption is reached, the weight of the anode electrode 235a changes with time. Since the weight of the anode electrode 235a affects the agitation state of the plating solution Q, it is estimated that the weight of the anode electrode 235a much affects the agitating motion of the target paddle TP or the detection value of the paddle vibration sensor 233f. Accordingly, when the plating process information includes the anode electrode information, the learning model 10 can be made to learn an influence of the state of the anode electrode 235a on the vibration characteristics of the target paddle TP.

Various types of information included in the operational motion information may be acquired as the detection values of the sensor group (the sensors 218, 228, 238, and 248) or the command values for the module group (the modules 217, 227, 237, and 247), or may be acquired as parameters which are converted to the detection values of the sensors or the command values for the modules, or may be acquired as parameters which are calculated based on detection values of a plurality of sensors. The operational motion information may be acquired from the device setting information 255 or the substrate recipe information 256. The operational motion information may be acquired as time-series data in a plating process period as a whole, may be acquired as time-series data in a target period which is a part of the plating process period, or may be acquired as time-point data at a specific target time point.

The operational-motion paddle vibration information is information indicating the vibration characteristics of the target paddle TP when the operational motion indicated by the operational motion information is performed. That is, the operational-motion paddle vibration information is information which is acquired in an environment in which the agitating motion of the target paddle TP and operational motions of the constituent parts other than the agitating motion are performed and is information based on vibration generated in the target paddle TP (including, for example, pump vibration, carrier machine vibration, and surrounding paddle vibration) due to the operational motions of the constituent parts.

The vibration characteristics in the operational-motion paddle vibration information may be acquired as a detection value of the paddle vibration sensor 233f when an operational motion is performed or may be acquired as vibration characteristic parameters which are converted or calculated from the detection value of the paddle vibration sensor 233f. For example, the vibration characteristics may be a time-axis waveform based on the detection value of the paddle vibration sensor 233f or may be features (such as an average value, a peak value, a standard deviation, or a variance) of the time-axis waveform. The vibration characteristics may be a frequency-axis waveform when frequency analysis is performed on the detection value of the paddle vibration sensor 233f or may be features (such as an average value, a peak value, an overall value, a standard deviation, or a variance) of the frequency-axis waveform. The operational-motion paddle vibration information may be acquired as time-series data in a plating process period as a whole, may be acquired as time-series data in a target period which is a part of the plating process period, or may be acquired as time-point data at a specific target time point.

In this embodiment, the operational-motion paddle vibration information is a result of frequency analysis as illustrated in FIG. 9 and is defined as vibration levels (A_L1, A_L2, . . . , A_Lk) at frequencies (F1, F2, . . . , Fk).

The agitating-motion paddle vibration information which is output data is information indicating the vibration characteristics of the target paddle TP when only the agitating motion indicated by the target paddle motion information of the operational motion information included in the plating process information which is input data is performed. That is, the agitating-motion paddle vibration information is information which is acquired in a quiet environment in which the operational motions of the constituent parts other than the agitating motion of the target paddle TP is not performed and is information based on only the vibration generated in the target paddle TP due to the agitating motion of the target paddle TP.

Similarly to the vibration characteristics in the operational-motion paddle vibration information, the vibration characteristics in the agitating-motion paddle vibration information may be acquired as the detection value of the paddle vibration sensor 233f when only the agitating motion is performed or may be acquired as vibration characteristic parameters which are converted or calculated from the detection value of the paddle vibration sensor 233f. For example, the vibration characteristics may be a time-axis waveform based on the detection value of the paddle vibration sensor 233f or may be features (such as an average value, a peak value, a standard deviation, or a variance) of the time-axis waveform. The vibration characteristics may be a frequency-axis waveform when frequency analysis is performed on the detection value of the paddle vibration sensor 233f or may be features (such as an average value, a peak value, an overall value, a standard deviation, or a variance) of the frequency-axis waveform. Here, the vibration characteristics in the agitating-motion paddle vibration information may be the same as the vibration characteristics in the operational-motion paddle vibration information or may be different therefrom. The agitating-motion paddle vibration information may be acquired as time-series data in a plating process period as a whole, may be acquired as time-series data in a target period which is a part of the plating process period, or may be acquired as time-point data at a specific target time point.

In this embodiment, the agitating-motion paddle vibration information is a result of frequency analysis as illustrated in FIG. 9 and is defined as vibration levels (T_L1, T_L2, T_Lk) at frequencies (F1, F2, . . . , Fk)

The learning model 10 employs, for example, a neural network structure and includes an input layer 100, an intermediate layer 101, and an output layer 102. Synapses (not illustrated) connecting neurons are provided between the layers, and a weighting is correlated with each synapse. A weighted parameter group including weightings of the synapses is adjusted through machine learning.

The input layer 100 includes neurons of the number corresponding to the plating process information which is input data, and the values of the plating process information are input to the neurons. The output layer 102 includes neurons of the number corresponding to the agitating-motion paddle vibration information which is output data, and an inference result (a prediction result) of the agitating-motion paddle vibration information in response to the plating process information is output as the output data. In this embodiment, the inference result of the agitating-motion paddle vibration information is output as vibration levels (E_L1, E_L2, . . . , E_Lk) at frequencies (F1, F2, Fk) indicating the result of frequency analysis as illustrated in FIG. 9.

(Machine Learning Method)

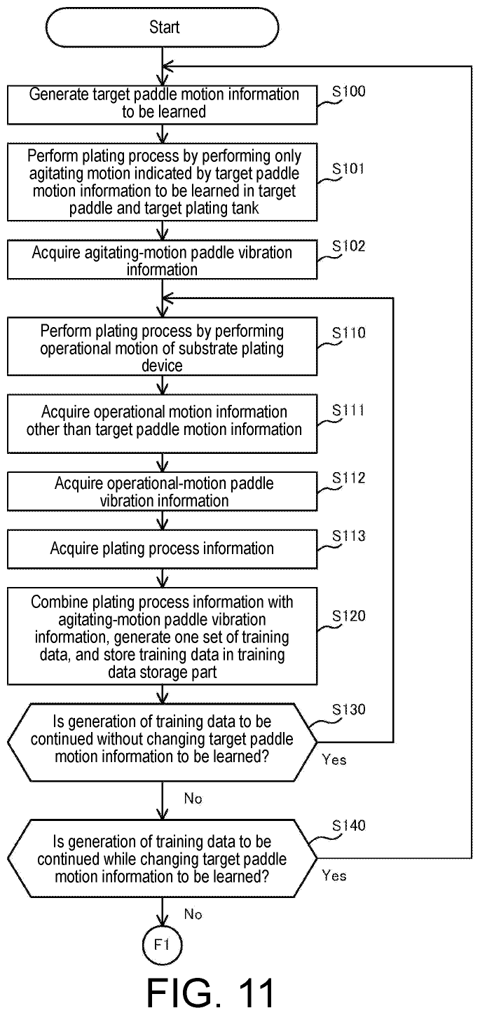

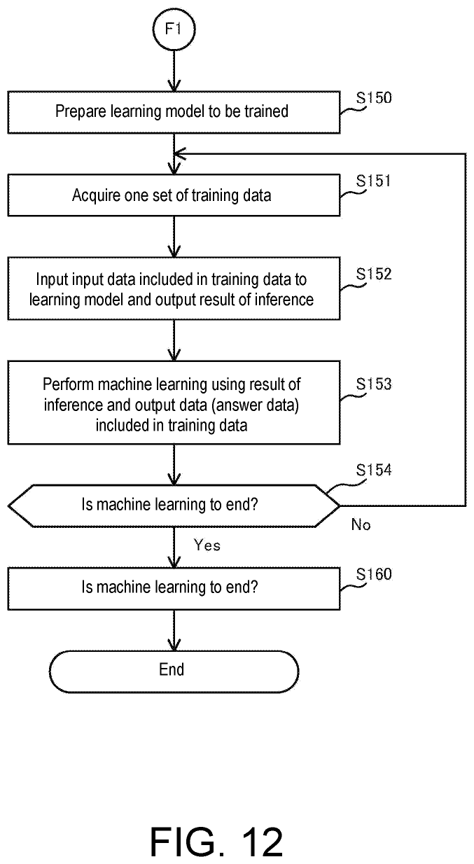

FIGS. 11 and 12 are flowcharts illustrating an example of a machine learning method that is performed by the machine learning device 3. In the following description, it is assumed that the training data 11 is acquired using the substrate plating device 2, but the training data 11 may be acquired using a testing device.

First, in Step S100, the training data generating part 300 of the machine learning device 3 generates target paddle motion information to be learned by selecting a target paddle TP out of a plurality of paddles 233a and, for example, setting the motion speed, the motion frequency, and the motion stroke of the target paddle TP to specific values. Then, the training data generating part 300 transmits the target paddle motion information to be learned to the substrate plating device 2.

Then, in Step S101, the substrate plating device 2 performs a plating process on a substrate W by performing only the agitating motion indicated by the target paddle motion information to be learned in the target paddle TP and the target plating tank TT.

Then, in Step S102, the substrate plating device 2 generates agitating-motion paddle vibration information by measuring vibration characteristics of the target paddle TP when only the agitating motion is performed in Step S101 using the paddle vibration sensor 233f. Then, the substrate plating device 2 transmits the agitating-motion paddle vibration information as report information 257 to the machine learning device 3, and the training data generating part 300 acquires the agitating-motion paddle vibration information corresponding to the target paddle motion information to be learned.

Then, in Step S110, the substrate plating device 2 performs operational motions of the constituent parts 21 to 24 (such as the motion of supplying a plating solution Q using the plating solution circulation part 232, the agitating motion of the paddle 233a using the plating solution agitating part 233, and the motion of carrying a substrate W using the substrate holder carrying part 24) by performing the plating process on a plurality of substrates W in parallel. At this time, the plating process is performed on the target paddle TP and the target plating tank TT and on the surrounding paddles SP and the surrounding plating tanks ST, and the agitating motion performed on the target paddle TP and the target plating tank TT is performed according to the agitating motion indicated by the target paddle motion information to be learned.

Then, in Step S111, the substrate plating device 2 generates operational motion information (the plating solution motion information, the carrier machine motion information, the surrounding paddle motion information, the device arrangement information, and the anode electrode information in this embodiment) other than the target paddle motion information by recording the detection values of the sensor group (the sensors 218, 228, 238, and 248) and the command values for the module group (the modules 217, 227, 237, and 247), and the like as the motion information when the operational motions are performed in Step S110. Then, the substrate plating device 2 transmits the generated information as report information 257 to the machine learning device 3, and the training data generating part 300 acquires the plating solution motion information, the carrier machine motion information, the surrounding paddle motion information, the device arrangement information, and the anode electrode information corresponding to the target paddle motion information to be learned.

In Step S112, the substrate plating device 2 generates operational-motion paddle vibration information by measuring the vibration characteristics of the target paddle TP when the operational motions are performed in Step S110 using the paddle vibration sensor 233f. Then, the substrate plating device 2 transmits the generated operational-motion paddle vibration information as report information 257 to the machine learning device 3, and the training data generating part 300 acquires the operational-motion paddle vibration information corresponding to the target paddle motion information to be learned.

Then, in Step S113, the training data generating part 300 generates operational motion information based on the target paddle motion information to be learned generated in Step S100 and the plating solution motion information, the carrier machine motion information, the surrounding paddle motion information, the device arrangement information, and the anode electrode information corresponding to the target paddle motion information to be learned acquired in Step S111, and acquires the plating process information by combining the generated operational motion information with the operational-motion paddle vibration information acquired in Step S112.

Then, in Step S120, the training data generating part 300 generates a set of training data 11 by combining the plating process information generated in Step S113 with the agitating-motion paddle vibration information acquired in Step S102 and stores the generated training data 11 in the training data storage part 32.

Then, in Step S130, the training data generating part 300 determines whether generation of training data 11 is to be continued by repeatedly performing the operational motion without changing the target paddle motion information to be learned. For example, when the number of pieces of the training data 11 is less than a predetermined number of pieces of data or when an input operation indicating continuation is received from a user, the training data generating part 300 determines that the generation is to be continued (Step S130: YES) and returns the routine to Step S110. Then, in Step S110, the operational motion of the substrate plating device 2 is continuously performed, and new training data 11 is generated in Steps S111 to S120 by performing the plating process on a new substrate W in a situation different from the situation in which the training data 11 has been previously acquired.

On the other hand, when it is determined in Step S130 that the generation is not to be continued (Step S130: NO), the routine proceeds to Step S140.

Then, in Step S140, the training data generating part 300 determines whether generation of training data 11 is to be continued by performing the operational motion while changing the target paddle motion information to be learned. For example, when the number of pieces of the training data 11 is less than a predetermined number of pieces of data or when an input operation indicating continuation is received from a user, the training data generating part 300 determines that the generation is to be continued (Step S140: YES) and returns the routine to Step S100. Then, in Step S100, the target paddle motion information to be learned is changed (for example, the motion speed of the target paddle TP is increased), new target paddle motion information to be learned is generated, agitating-motion paddle vibration information is acquired based on the new target paddle motion information to be learned in Step S102, and the plating process information is acquired in Steps S110 to S113. As a result, new training data 11 is generated in Step S120.

On the other hand, when it is determined in Step S140 that the generation is not to be continued (Step S140: NO), the routine proceeds to Step S150.

Then, in Step S150, the machine learning part 301 prepares a learning model 10 to be trained. The learning model 10 to be trained is, for example, a model of a neural network as illustrated in FIG. 9, may be a non-trained learning model 10 in which the weightings of the synapses are set to initial values, or may be a learning model 10 which was previous trained when re-training is performed.

Then, in Step S151, the machine learning part 301, for example, randomly acquires one set of training data 11 from a plurality of sets of training data 11 stored in the training data storage part 32.

Then, in Step S152, the machine learning part 301 inputs the plating process information (input data) included in the set of training data 11 to the input layer 100 of the learning model 10 to be trained (before training or during training) prepared in Step S150. As a result, agitating-motion paddle vibration information (output data) as a result of inference is output from the output layer 102 of the learning model 10, and this output data is generated by the learning model 10 to be trained (before training or during training). Accordingly, the output data output as the result of inference does not match the agitating-motion paddle vibration information (answer data) included in the training data 11.

Then, in Step S153, the machine learning part 301 performs machine learning by comparing the agitating-motion paddle vibration information (output data) output as the result of inference from the output layer in Step S152 with the agitating-motion paddle vibration information (answer data) included in the set of training data 11 acquired in Step S151 and performing a process of adjusting the weightings of the synapses (back propagation). Accordingly, the machine learning part 301 causes the learning model 10 to learn the correlation between the plating process information and the agitating-motion paddle vibration information.

Then, in Step S154, the machine learning part 301 determines whether a predetermined training end condition has been satisfied, for example, based on an evaluated value of an error function based on the agitating-motion paddle vibration information (answer data) included in the training data 11 and the agitating-motion paddle vibration information (output data) output as the result of inference or the number of pieces of the non-trained training data 11 stored in the training data storage part 32.

When it is determined in Step S154 that the training end condition has not been satisfied and machine learning is to be continuously performed (Step S154: NO), the machine learning part 301 returns the routine to Step S151 and performs the processes of Steps S151 to S154 on the learning model 10 during training a plurality of times using the untrained training data 11. On the other hand, when it is determined in Step S154 that the training end condition has been satisfied and machine learning is to end (Step S154: YES), the machine learning part 301 causes the routine to proceed to Step S160.

Then, in Step S160, the machine learning part 301 stores the trained learning model 10 (the adjusted weighted parameter group) generated by adjusting the weightings correlated with the synapses in the trained model storage part 33 and ends the routine of the machine learning method illustrated in FIGS. 11 and 12.

In the machine learning method, Steps S100 to S140 correspond to a training data generating step, Step S120 corresponds to a training data storing step, Steps S150 to S154 correspond to a machine learning step, and Step S160 corresponds to a trained model storing step. In the aforementioned description, the processes of Step S150 and steps subsequent thereto are performed subsequently to Step S140, but the training data generating step of Steps S110 to S140 and the machine learning step of Steps S150 to S160 may be separately performed. The training data generating step may be performed using a plurality of substrate plating devices 2 or a plurality of testing devices. The training data generating step is performed, for example, using a new product or a normal paddle 233a of which operation check has been completed to generate a plurality of sets of training data 11, and a plurality of paddles 233a in which use circumstances such as a use time or a use frequency of the paddle 233a are different may be used at that time. Some sets of training data 11 of the plurality of sets of training data 11 may be generated using a paddle 233a in which an abnormality has occurred or may be generated using a plurality of paddles 233a in which statuses of an abnormality such as an occurrence level or a type of an abnormality are different. In the training data generating step, the training data generating part 300 may generate the training data 11 by acquiring the operational motion information other than the target paddle motion information in Step S111 and the operational-motion paddle vibration information in Step S112 using the target paddle motion information to be learned as a retrieval key with reference to the report information 257 stored in the storage part 254 or the like by performing the plating process in the past instead of or in addition to generating of the training data 11 by performing the plating process using the substrate plating device 2 in Step S110.

As described above, with the machine learning device 3 and the machine learning method according to this embodiment, it is possible to provide a learning model 10 that can generate (infer) agitating-motion paddle vibration information from plating process information including motion status information and operational-motion paddle vibration information.

(Information Processing Device 4)

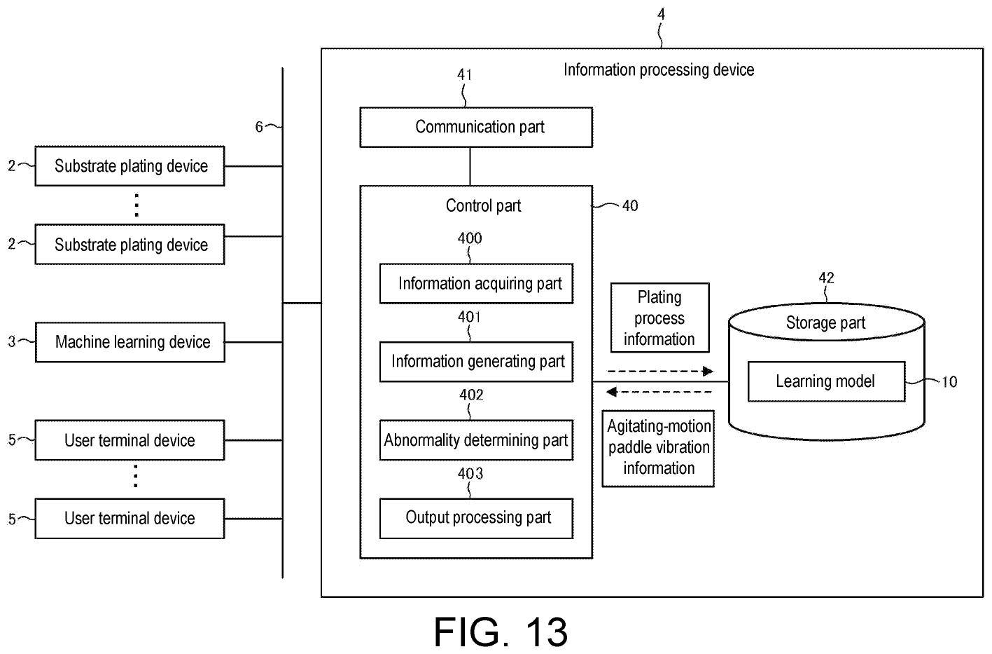

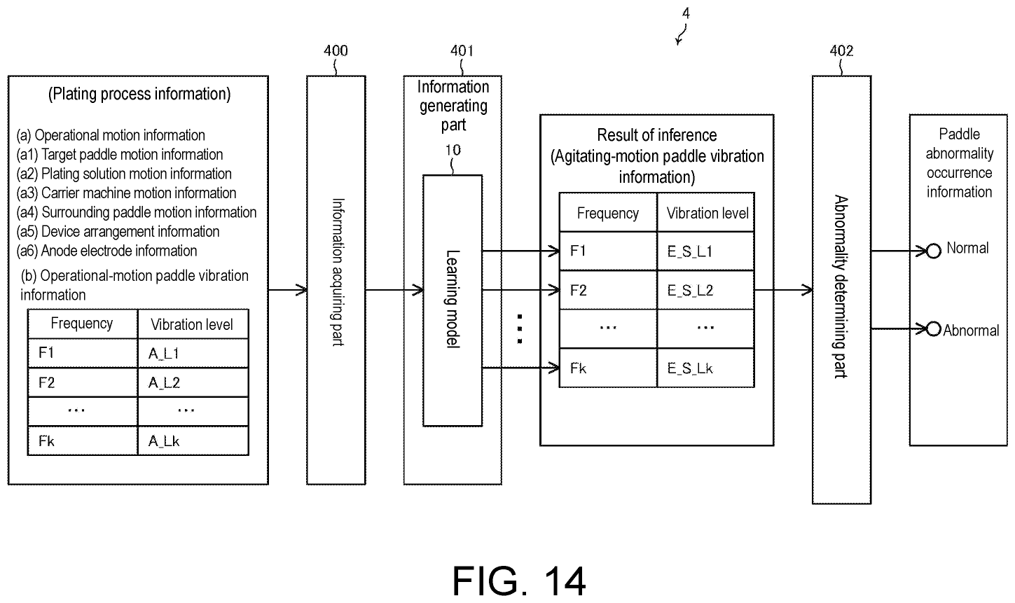

FIG. 13 is a block diagram illustrating an example of the information processing device 4. FIG. 14 is a functional diagram illustrating an example of the information processing device 4. The information processing device 4 includes a control part 40, a communication part 41, and a storage part 42.

The control part 40 serves as an information acquiring part 400, an information generating part 401, an abnormality determining part 402, and an output processing part 403. The communication part 41 is connected to an external device (for example, the substrate plating device 2, the machine learning device 3, or the user terminal device 5) via the network 6 and serves as a communication interface transmitting and receiving various types of data. The storage part 42 stores various programs (such as an operating system and a user terminal program) or data (the learning model 10), and the like which are used to operate the information processing device 4.

The information acquiring part 400 is connected to an external device via the communication part 41 and the network 6 and acquires the plating process information including the motion status information and the operational-motion paddle vibration information of the target paddle TP. In this embodiment, the operational-motion paddle vibration information is a result of frequency analysis as illustrated in FIG. 14 and is defined as vibration levels (A_L1, A_L2, . . . , A_Lk) at frequencies (F1, F2, Fk).

For example, while an operational motion is actually being performed by the substrate plating device 2, the information acquiring part 400 acquires the motion status information and the operational-motion paddle vibration information while the plating process is being performed on a substrate W as the plating process information from time to time by receiving report information 257 on the operational motion from the substrate plating device 2 from time to time. When the operational motion has been performed by the substrate plating device 2, the information acquiring part 400 acquires the motion status information and the operational-motion paddle vibration information when the plating process has been performed on a substrate W as the plating process information with reference to the report information 257 stored in the storage part 254 of the substrate plating device 2. The information acquiring part 400 may acquire a part of the motion status information with reference to the device setting information 255 or the substrate recipe information 256 of the substrate plating device 2.

The information generating part 401 generates agitating-motion paddle vibration information in response to the plating process information by inputting the plating process information acquired by the information acquiring part 400 as input data to the learning model 10. In this embodiment, the agitating-motion paddle vibration information is a result of frequency analysis as illustrated in FIG. 14 and is output as vibration levels (E_L1, E_L2, . . . , E_Lk) at frequencies (F1, F2, . . . , Fk).

The trained learning model 10 used for the information generating part 401 is stored in the storage part 42. The number of learning models 10 stored in the storage part 42 is not limited to 1, and a plurality of learning models having different conditions such as a method of the machine learning, a mechanism difference of the plating processing part 23, a mechanism difference of the substrate holder carrying part 24, a data type included in the plating process information, and a data type included in the agitating-motion paddle vibration information may be stored and be able to be selectively used. A storage part of an external computer (for example, a server computer or a cloud computer) may be used as the storage part 42. In this case, the information generating part 401 can access the external computer.

The abnormality determining part 402 determines occurrence of an abnormality in the target paddle TP based on the agitating-motion paddle vibration information generated by the information generating part 401. The abnormality determining part 402 generates paddle abnormality occurrence information indicating the result of determination.

Various methods can be employed for the abnormality determining part 402 to determine occurrence of an abnormality in the target paddle TP. For example, the abnormality determining part 402 calculates a degree of separation between the vibration characteristics indicated by the agitating-motion paddle vibration information and the normal vibration characteristics (which may be theoretical values) acquired when the paddle 233a is normal and determines occurrence of an abnormality based on whether the degree of separation departs from a predetermined normal range. The degree of separation may be, for example, a distance based on dynamic time warping (DTW) or a Mahalanobis distance. The abnormality determining part 402 may input the agitating-motion paddle vibration information to a learning model trained in unsupervised learning and determine occurrence of an abnormality based on a determination value output from the learning model. The occurrence of an abnormality may include a sign of an abnormality, whether an abnormality has occurred (normality/abnormality) may be determined as illustrated in FIG. 14, or an occurrence level of an abnormality may be determined in a plurality of steps. When a plurality of occurrence reasons of an abnormality are assumed, whether an abnormality has occurred or the occurrence level of an abnormality may be determined as the occurrence of an abnormality for each occurrence reason of an abnormality.

The output processing part 403 performs an output process of outputting the agitating-motion paddle vibration information generated by the information generating part 401 and the paddle abnormality occurrence information generated by the abnormality determining part 402. The output process is an arbitrary process such as storage, communication, display, or printing of the agitating-motion paddle vibration information and the paddle abnormality occurrence information, and the output processing part 403 may display a display screen based on the agitating-motion paddle vibration information and the paddle abnormality occurrence information on the substrate plating device 2, for example, by transmitting the agitating-motion paddle vibration information and the paddle abnormality occurrence information to the substrate plating device 2.

(Information Processing Method)

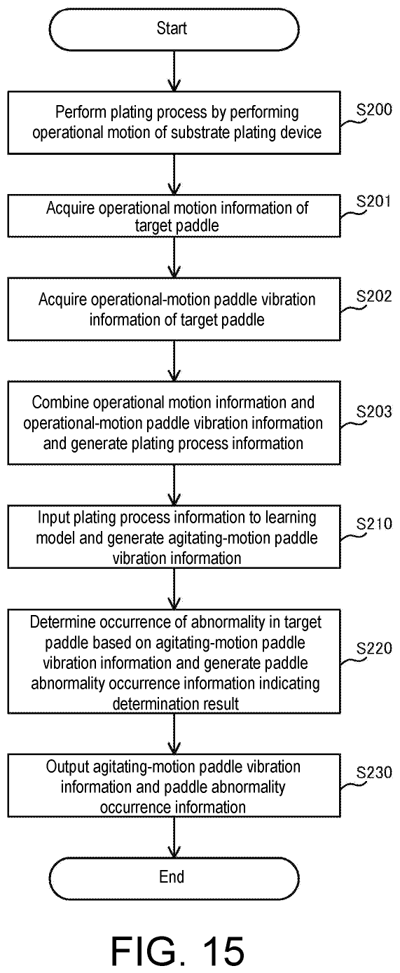

FIG. 15 is a flowchart illustrating an example of an information processing method that is performed by the information processing device 4. In the following description, it is assumed that the information processing device 4 monitors occurrence of an abnormality in a paddle 233a (a target paddle TP) by acquiring plating process information from the substrate plating device 2 when the substrate plating device 2 performs a plating process on a substrate W.

First, in Step S200, the substrate plating device 2 performs operational motions of the constituent parts 21 to 24 (such as a motion of supplying a plating solution Q using the plating solution circulation part 232, an agitating motion of the paddle 233a using the plating solution agitating part 233, and a motion of carrying a substrate W using the substrate holder carrying part 24) by performing the plating process on a plurality of substrates W in parallel.

Then, in Step S201, the substrate plating device 2 generates target paddle motion information, plating solution motion information, carrier machine motion information, surrounding paddle motion information, device arrangement information, and anode electrode information by recording detection values from the sensor group (sensors 218, 228, 238, and 248), command values for the module group (modules 217, 227, 237, and 247), or the like as motion information when the operational motions are performed in Step S200. Then, the substrate plating device 2 transmits such information as report information 257 to the information processing device 4, and the information acquiring part 400 acquires operational motion information including the target paddle motion information, the plating solution motion information, the carrier machine motion information, the surrounding paddle motion information, the device arrangement information, and the anode electrode information as a result.

In Step S202, operational-motion paddle vibration information is generated by measuring vibration characteristics of the target paddle TP when the operational motions are performed in Step S200 using the paddle vibration sensor 233f. Then, the substrate plating device 2 transmits the operational-motion paddle vibration information as report information 257 to the information processing device 4, and the information acquiring part 400 acquires the operational-motion paddle vibration information.

Then, in Step S203, the information acquiring part 400 generates plating process information by combining the operational motion information acquired in Step S201 and the operational-motion paddle vibration information acquired in Step S202.

Then, in Step S210, the information generating part 401 generates agitating-motion paddle vibration information in response to the plating process information based on output data which is output by inputting the plating process information acquired in Step S203 as input data to the learning model 10.

Then, in Step S220, the abnormality determining part 402 determines occurrence of an abnormality in the target paddle TP based on the agitating-motion paddle vibration information generated in Step S210 and generates paddle abnormality occurrence information indicating the result of determination.

Then, in Step S230, the output processing part 403 transmits the agitating-motion paddle vibration information and the paddle abnormality occurrence information to at least one of the substrate plating device 2 and the user terminal device 5 in an output process of outputting the agitating-motion paddle vibration information generated in Step S210 and the paddle abnormality occurrence information generated in Step S220. Then, the substrate plating device 2 and the user terminal device 5 receive the agitating-motion paddle vibration information and the paddle abnormality occurrence information from the information processing device 4 and displays a display screen based on the agitating-motion paddle vibration information and the paddle abnormality occurrence information. When the paddle abnormality occurrence information indicates that an abnormality has occurred in the target paddle TP, a user may be notified of occurrence of the abnormality or the operational motions of the substrate plating device 2 may be stopped.

In the information processing method, Steps S200 to S203 correspond to an information acquiring step, Step S210 corresponds to an information generating step, Step S220 corresponds to an abnormality determining step, and Step S230 corresponds to an output processing step. In this embodiment, since the substrate plating device 2 includes 16 plating tanks 230 and 16 paddles 233a, the plating process is performed in the 16 plating tanks 230 in parallel and the agitating motion is performed in the 16 paddles 233a when the operational motions in the substrate plating device 2 are performed in Step S200. Accordingly, Steps S201 to S230 are performed with each of the 16 paddles 233a as the target paddle TP.

As described above, with the information processing device 4 and the information processing method according to this embodiment, since agitating-motion paddle vibration information indicating the vibration characteristics of a target paddle TP when only the agitating motion is performed is generated by inputting the plating process information including the operational motion information indicating operational motions performed by the substrate plating device 2 and the operational-motion paddle vibration information indicating the vibration characteristics of the target paddle TP when the operational motions are performed to the learning model 10, it is possible to appropriately predict the vibration characteristics of the paddles according to the motion status of the substrate plating device 2.

Here, the learning model 10 to which the plating process information is input is obtained by learning a correlation between the operational motion information and the operational-motion paddle vibration information which are input data and the agitating-motion paddle vibration information which is output data, and thus serves as a filter removing vibration due to the operational motions of the constituent parts other than the agitating motion (for example, pump vibration, carrier machine vibration, and surrounding paddle vibration) as noise from the vibration characteristics of the target paddle TP when the input operational motions are performed (the operational-motion paddle vibration information) and extracting the vibration characteristics of the target paddle TP when only the agitating motion is performed (the agitating-motion paddle vibration information). Accordingly, it is possible to appropriately predict the vibration characteristics of the paddles according to the motion status of the substrate plating device 2. Since an influence of the vibrations due to the operational motions of the constituent parts other than the agitating motion (for example, pump vibration, carrier machine vibration, and surrounding paddle vibration) can be reduced using the agitating-motion paddle vibration information which is output as a result, for example, for determination of an abnormality in the target paddle TP, it is possible to accurately determine occurrence of an abnormality in the target paddle TP.

### Other Embodiments

The disclosure is not limited to the aforementioned embodiment and can be modified in various forms without departing from the gist of the disclosure. All the modifications are included in the technical spirit of the disclosure.

In the aforementioned embodiment, the machine learning device 3, the information processing device 4, and the user terminal device 5 are configured as separate devices, but the three devices may be configured as a single device or two arbitrary devices of the three devices may be configured as a single device. At least one of the machine learning device 3 and the information processing device 4 may be incorporated into the control unit 25 of the substrate plating device 2 or the user terminal device 5, or the substrate plating device 2 or the user terminal device 5 may operate as at least one of the machine learning device 3 and the information processing device 4. For example, the learning model 10 may be stored in the storage part 254 of the substrate plating device 2 and the control part 250 may serve as the information acquiring part 400, the information generating part 401, the abnormality determining part 402, and the output processing part 403 of the information processing device 4.

In the aforementioned embodiment, the substrate plating device 2 is a substrate plating device called a dipping type, but the substrate plating device 2 is not limited to the aforementioned configuration as long as it is a device performing a plating process on a substrate W and may be applied to, for example, a substrate plating device 2 called a cup type.

In the aforementioned embodiment, a neural network is employed as the learning model for realizing machine learning which is performed by the machine learning part 301, but another machine learning model may be employed. Examples of another machine learning model include a tree type such as a decision tree or a regression tree, ensemble learning such as bagging or boosting, a neural net type (including deep learning) such as a regression type neural network, a convolutional neural network, or an LSTM, a clustering type such as hierarchical clustering, non-hierarchical clustering, or a k-nearest neighbors algorithm, or k-means clustering, multivariate analysis such as principal component analysis, factor analysis, or logistic regression, and a support vector machine.

In the aforementioned embodiment, the machine learning device 3 and the information processing device 4 are applied to the substrate plating device 2, but they may be applied to an arbitrary device other than the substrate plating device 2 as long as it includes a mechanism vibrating due to reciprocating or rotating at the time of operation similarly to the paddle 233a.

(Machine Learning Program and Information Processing Program)

The disclosure may be provided in a form of a program causing the computer 900 to serve as the constituent parts of the machine learning device 3 (a machine learning program) or a program causing the computer 900 to perform the processing steps of the machine learning method (a machine learning program). The disclosure may be provided in a form of a program causing the computer 900 to serve as the constituent parts of the information processing device 4 or the user terminal device 5 (an information processing program) or a program causing the computer 900 to perform the processing steps of the machine learning method according to the embodiment (an information processing program).

(Inference Device, Inference Method, and Inference Program)

The disclosure may be provided in a form of an inference device (an inference method or an inference program) that is used to infer the agitating-motion paddle vibration information as well as the form of the information processing device 4 (the information processing method or the information processing program) according to the embodiment. In this case, the inference device (the inference method or the inference program) includes a memory and a processor and can be realized by causing the processor to perform a series of processes. The series of processes includes an information acquiring process (the information acquiring step) of acquiring the plating process information and an inference process (an inference step) of inferring the agitating-motion paddle vibration information indicating the vibration characteristics of a target paddle TP when only the agitated motion indicated by the target paddle motion information of the operational motion information included in the plating process information is performed when the plating process information is acquired in the information acquiring process.

By providing the disclosure in the form of the inference device (the inference method or the inference program), the disclosure can be more simply applied to various devices in comparison with a case in which the information processing device is mounted. It will be able to be understood by those skilled in the art that the inference technique performed by the information generating part can be applied using a trained learning model generated by the machine learning device and the machine learning method according to the embodiment when the inference device (the inference method or the inference program) infers the agitating-motion paddle vibration information.

What is claimed is:

1. An information processing device comprising:
an information acquiring part configured to acquire plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and
an information generating part configured to generate agitating-motion paddle vibration information in response to the plating process information by inputting the plating process information acquired by the information acquiring part to a learning model which has learned a correlation between the plating process information and the agitating-motion paddle vibration information indicating vibration characteristics of the target paddle when only the agitating motion indicated by the target paddle motion information of the operational motion information included in the plating process information has been performed using machine learning.

2. The information processing device according to claim 1, wherein the target paddle motion information includes at least one of:
a motion speed of the target paddle;
a motion frequency of the target paddle; and
a motion stroke of the target paddle.

3. The information processing device according to claim 1, wherein the plating solution motion information includes at least one of:
an amount of liquid of the plating solution stored in the plating tank;
a motion status indicating whether a circulation pump circulating the plating solution is operating; and
a rotation speed of the circulation pump.

4. The information processing device according to claim 1, wherein the carrier machine motion information includes at least one of:
a motion status indicating whether the carrier machine is operating;
a motion speed of the carrier machine;
a position of the carrier machine relative to the target paddle; and
a distance between the target paddle and the carrier machine.

5. The information processing device according to claim 1, wherein the substrate plating device includes:
a target plating tank corresponding to the plating tank in which the target paddle is installed and a surrounding plating tank corresponding to the plating tank disposed near the target plating tank as a plurality of the plating tanks; and
the target paddle and a surrounding paddle corresponding to the paddle installed in the surrounding plating tank as a plurality of the paddles,
wherein the operational motion information further includes surrounding paddle motion information indicating the agitating motion of the surrounding paddle.

6. The information processing device according to claim 5, wherein the surrounding paddle motion information includes at least one of:
a motion state indicating whether the surrounding paddle is operating;
a motion speed of the surrounding paddle;
a motion frequency of the surrounding paddle;
a motion stroke of the surrounding paddle; and
a phase difference between the target paddle and the surrounding paddle.

7. The information processing device according to claim 5, wherein the operational motion information further includes device arrangement information on arrangement of the plating tanks and the paddles, and
wherein the device arrangement information includes at least one of:
a position of the surrounding paddle relative to the target paddle;
a distance between the target paddle and the surrounding paddle;
a position of the surrounding plating tank relative to the target plating tank; and
a distance between the target plating tank and the surrounding plating tank.

8. The information processing device according to claim 1, wherein the operational motion information further includes anode electrode information on an anode electrode installed in the plating tank, and
wherein the anode electrode information includes at least a weight of the anode electrode.

9. The information processing device according to claim 1, further comprising an abnormality determining part configured to determine occurrence of an abnormality in the target paddle based on the agitating-motion paddle vibration information generated by the information generating part.

10. The information processing device according to claim 2, further comprising an abnormality determining part configured to determine occurrence of an abnormality in the target paddle based on the agitating-motion paddle vibration information generated by the information generating part.

11. The information processing device according to claim 3, further comprising an abnormality determining part configured to determine occurrence of an abnormality in the target paddle based on the agitating-motion paddle vibration information generated by the information generating part.

12. The information processing device according to claim 4, further comprising an abnormality determining part configured to determine occurrence of an abnormality in the target paddle based on the agitating-motion paddle vibration information generated by the information generating part.

13. The information processing device according to claim 5, further comprising an abnormality determining part configured to determine occurrence of an abnormality in the target paddle based on the agitating-motion paddle vibration information generated by the information generating part.

14. An inference device comprising a memory and a processor,
wherein the processor performs:
an information acquiring process of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and
an inference process of inferring agitating-motion paddle vibration information indicating vibration characteristics of the target paddle when only the agitating motion indicated by the target paddle motion information of the operational motion information included in the plating process information has been performed when the plating process information is acquired in the information acquiring process.

15. A machine learning device comprising:
a training data storage part configured to store a plurality of sets of training data including plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed and agitating-motion paddle vibration information indicating vibration characteristics of the target paddle when only the agitating motion indicated by the target paddle motion information of the operational motion information included in the plating process information has been performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks;
a machine learning part configured to cause a learning model to learn a correlation between the plating process information and the agitating-motion paddle vibration information through machine learning by inputting the plurality of sets of training data to the learning model; and
a trained model storage part configured to store the learning model which has been caused to learn the correlation by the machine learning part.

16. A substrate plating device for performing operational motions, the substrate plating device serving as:
the information processing device according to claim 1.

17. A substrate plating device for performing operational motions, the substrate plating device serving as:
the machine learning device according to claim 15.

18. An information processing method comprising:
an information acquiring step of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and
an information generating step of generating agitating-motion paddle vibration information in response to the plating process information by inputting the plating process information acquired in the information acquiring step to a learning model which has learned a correlation between the plating process information and the agitating-motion paddle vibration information indicating vibration characteristics of the target paddle when only the agitating motion indicated by the target paddle motion information of the operational motion information included in the plating process information has been performed using machine learning.

19. An inference method that is performed by an inference device including a memory and a processor,
wherein the processor performs:
an information acquiring process of acquiring plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks; and
an inference process of inferring agitating-motion paddle vibration information indicating vibration characteristics of the target paddle when only the agitating motion indicated by the target paddle motion information of the operational motion information included in the plating process information has been performed when the plating process information is acquired in the information acquiring process.

20. A machine learning method comprising:
a training data storing step of storing, in a training data storage part, a plurality of sets of training data including plating process information including operational motion information including target paddle motion information indicating an agitating motion of a target paddle corresponding to a paddle to be processed, plating solution motion information indicating a motion of supplying a plating solution to a plating tank, and carrier machine motion information indicating a motion of carrying a substrate and operational-motion paddle vibration information indicating vibration characteristics of the target paddle when an operational motion is performed and agitating-motion paddle vibration information indicating vibration characteristics of the target paddle when only the agitating motion indicated by the target paddle motion information of the operational motion information included in the plating process information has been performed, the motion of agitating the target paddle, the motion of supplying a plating solution, and the motion of carrying a substrate being operational motions which are performed by a substrate plating device including one or more plating tanks storing a plating solution used for plating of a substrate, one or more paddles installed in the one or more plating tanks and agitating the plating solution, and one or more carrier machines carrying the substrate to the one or more plating tanks;
a machine learning step of causing a learning model to learn a correlation between the plating process information and the agitating-motion paddle vibration information through machine learning by inputting the plurality of sets of training data to the learning model; and
a trained model storing step of storing the learning model which has been caused to learn the correlation in the machine learning step in a trained model storage part.
